(19) United States
(12) Patent Application Publication
(10) Pub. No.: US 2016/0278893 A1
(43) Pub. Date: Sep. 29, 2016

(54) METHOD AND DEVICE FOR SECURING PREFABRICATED PROSTHETIC TEETH

(71) Applicant: HERAEUS KULZER GMBH, Hanau (DE)

(72) Inventors: Novica Savic, Erlensee (DE); Karl-Heinz Renz, Alzenau (DE); Frank-Uwe Stange, Langenargen (DE); Stefan Rombeck, Uhldingen-Mühlhofen (DE)

(21) Appl. No.: 15/037,396

(22) PCT Filed: Nov. 7, 2014
(86) PCT No.: PCT/EP2014/074034

§ 371 Date: May 18, 2016

(30) Foreign Application Priority Data
Nov. 19, 2013 (DE) 102013112747.9

(51) Int. Cl. A61C 13/12; A61C 13/08; A61C 13/00

(52) U.S. Cl. CPC A61C 13/12; A61C 13/0004; A61C 13/0027; A61C 13/08; A61C 13/0006

(57) ABSTRACT

The invention relates to a method for positioning and machining prosthetic teeth, comprising the following method steps:
(a) at least two clamping jaws with peripheral recesses are placed with the peripheral recesses against a prefabricated prosthetic tooth or against prefabricated prosthetic teeth, such that, at least in certain regions, the placed clamping jaws enclose the prosthetic tooth or the prosthetic teeth respectively around a middle circumference, wherein, at least in certain regions, the inner surfaces of the recesses positive fit regions of the outer surfaces of the prosthetic tooth or the prosthetic teeth, wherein the clamping jaws are placed against the prosthetic tooth or the prosthetic teeth in such a manner that the coronal end and the basal end of the prosthetic tooth or the coronal ends and the basal ends of the prosthetic teeth project on both sides of the placed-together clamping jaws; and
(b) fastening the clamping jaws to one another.

The invention also relates to a kit for performing such a method and a device for holding prosthetic teeth.

The invention relates to a method for positioning and machining prosthetic teeth.

The invention also relates to a device for holding prosthetic teeth and a kit for performing such a method using such a device.

The invention thus relates to the manufacture and provision of prefabricated dental blocks (prosthetic teeth) for further processing into partial and total plastic dentures, which are produced by machine in a CAM process (computer-aided manufacturing) and designed using a CAD process (computer-aided design). The dental bridges can be provided as semi-finished products for the partial or complete manufacture of plastic dentures using CAM processes.

The method currently used is the analog creation of prosthetic teeth. Prosthetic teeth are set up manually and individually on a wax base. In a next step, this wax prosthesis is embedded in dental plaster in a cuvette, and the wax base is washed out with hot water after the dental plaster has cured to create a hollow space for the denture resin. The prosthetic teeth remain in the dental plaster during this step. A respective dental plaster is injected or “plugged” into the hollow space to result in the denture or the finished prosthetic tooth after the plastic material has cured.

When setting up prefabricated prosthetic teeth, the dental technician adjusts them to the patient's oral situation and grinds them. There are already some methods available, such as the methods known from DE 10 2009 056 752 A1 or WO 2013 124 452 A1, in which the partial or total denture is set up digitally and produced using CAD-CAM processes.

A disadvantage of these methods is that the prosthetic teeth are positioned in a denture carrier plate. The typical procedure is to prefabricate a custom-fit cavity in a denture carrier plate and then to glue in the prefabricated prosthetic teeth. But this will only work if there is enough space and if the prefabricated prosthetic teeth do not have to be ground from below (at the base). That would rather be the exception. In most cases, the prosthetic tooth has to be ground for space reasons. Prefabricated prosthetic teeth typically have to be machined at least on the base as part of prosthetic procedures. If processing is manual, the operator will machine each prosthetic tooth individually. In this case, it will no longer fit into the prefabricated cavity in the denture carrier plate.

DE 10 2011 101 678 A1 proposes to embed the crown area of a prosthetic tooth in a support layer and then to machine the prosthetic tooth. The prosthetic teeth are either fastened using wax or other meltable or curable compounds. This will provide a firm and precise bond and at the same time a defined positioning of the prosthetic teeth. A disadvantage is that certain regions of the prosthetic tooth have to be exposed to machine the embedded crown area. Another disadvantage of the method is the rather complex manufacturing of the dentures. These are produced individually or in groups by inserting the finished prosthetic teeth in a holder, placing an external frame on top, and subsequently potting the denture using a bonding medium (e.g. wax). This makes pouring the compound that forms the support layer around the prosthetic teeth technically elaborate.

The support layer has to cure before the prosthetic tooth can be machined, since automated CAM grinding, in particular, will involve considerable forces. The positioning accuracy of the method is also threatened by potential deformation of the support layer when it has not yet fully cured, such that in extreme cases the reworked prosthetic tooth is not ground out precisely enough and has to be discarded. Furthermore, such a support layer often can only be removed completely from the prosthetic tooth with some effort. The material for making the support layer must be in stock and may have to be mixed, molten, or activated prior to application. It has to be disposed of after use.

It is therefore the problem of the invention to overcome the disadvantages of prior art. Particularly, a device and a method are to be provided which allow processing of the prosthetic teeth as simply, completely, and cost effectively as possible. The method should require as few reworking steps as possible. As many necessary parts as possible should be reusable. It should not be necessary to rework the finished re-machined prosthetic teeth.

The problems of the invention are solved by a method for positioning and machining prosthetic teeth, comprising the following process steps:

1) at least two clamping jaws with peripheral recesses are placed with the peripheral recesses against a prefabricated prosthetic tooth or against prefabricated prosthetic teeth, such that, at least in certain regions, the placed clamping jaws enclose the prosthetic tooth or the prosthetic teeth respectively around a middle circumference, wherein, at least in certain regions, the inner surfaces of the recesses positive fit regions of the outer surfaces of the prosthetic tooth or the prosthetic teeth, wherein the clamping jaws are placed against the prosthetic tooth or the prosthetic teeth in such a manner that the coronal end and the basal end of the prosthetic tooth or the coronal ends and the basal ends of the prosthetic teeth project on both sides of the placed-together clamping jaws; and

2) fastening the clamping jaws to one another.

According to the invention, it is preferred that multiple prosthetic teeth are fixed in the clamping jaws. The advantage is that multiple prosthetic teeth held in the clamping jaws can then be machined in one single step in one process.

According to the invention, the clamping jaws can further be fastened to one another using a fastening means that is or can be attached to the clamping jaws.

Furthermore, the clamping jaws can be placed against the prosthetic tooth or the prosthetic teeth in such a manner that the clamping jaws are in positive fitting contact and flush with one another and/or with the prosthetic tooth or the clamping jaws are in positive fitting contact and flush with one another and/or with the prosthetic teeth.

This provides a particularly stable and torsion resistant clamping and in addition a more even distribution of forces that act on the prosthetic tooth or the prosthetic teeth.

The invention also proposes that the prefabricated prosthetic tooth or the prefabricated prosthetic teeth is/are coronally and/or basally set onto a carrier before being fixed by the clamping jaws, and that the carrier is removed from the clamping jaws and the prosthetic tooth or teeth held in the clamping jaws after the clamping jaws have been connected to one another.

This allows for easier implementation and handling of the method.

Since the clamping jaws are placed against the prosthetic tooth or the prosthetic teeth in such a manner that the coronal end and the basal end of the prosthetic tooth or the coronal ends and the basal ends of the prosthetic teeth project on both sides of the placed-together clamping jaws, it is possible to use the clamping jaws or the holder simultaneously for reworking the coronal side or the occlusal side and the basal side.

It is further proposed that the clamping jaws be placed against the prosthetic tooth or the prosthetic teeth while on the carrier.

This ensures particularly easy alignment of the clamping jaws with the prosthetic teeth.

Furthermore, a carrier plate with at least one cavity for at least one prefabricated prosthetic tooth can be used as the carrier, wherein the at least one cavity forms a negative of the outer shape of the coronal end or the basal end of a prefabricated prosthetic tooth, wherein preferably a carrier plate with a plurality of cavities for a plurality of prosthetic teeth is used and each cavity forms a negative of the outer shape of a coronal end and/or a basal end of the prefabricated prosthetic teeth.

Carrier plates are the simplest form of a carrier and can also be useful when aligning the clamping jaws.

A further development of the invention also proposes that, particularly after removing the carrier, the clamping jaws attached to one another be fastened in a defined position in a holder of a CAM device for material removal from the prosthetic teeth or the prosthetic tooth in a CAM process, and at least one coronal end and/or at least one basal end of at least one prosthetic tooth is machined in a computer-controlled process using the CAM device, wherein the CAM device preferably is a CAM-controlled milling cutter, particularly a CAM-controlled four-axis milling cutter.

This step utilizes the advantages a device and the method according to the invention has for positioning for automated processes in which exact positioning according to the invention is particularly advantageous.

In preferred embodiments of the method, the outer shapes of all prefabricated prosthetic teeth used can be available as a first dataset, and a second dataset can define the exact positions of all fixed prefabricated prosthetic teeth in the placed-together clamping jaws, wherein subsequent machining of the prosthetic tooth or the prosthetic teeth is performed based on the first and the second dataset, preferably subsequent machining using a CAD/CAM process.

This makes the advantages of fixation accessible to fully automated reworking processes, for which they are particularly well suited. It is only the claimed fixation that facilitates simple and cost-effective provision of the prosthetic teeth at high precision and accuracy of position.

In preferred methods, all prefabricated prosthetic teeth can be fixed in one predetermined position and orientation only in the placed-together clamping jaws.

This ensures a distinct position and orientation for reworking without having to re-check the position and orientation.

In a further development of the invention, it is proposed that the prefabricated prosthetic tooth used or the prefabricated prosthetic teeth used is/are produced using a CAD process, wherein the data used to determine the outer shape of the surface of the prefabricated prosthetic tooth or the prefabricated prosthetic teeth are used for shaping the recesses of the clamping jaws, wherein preferably at least the recesses in the clamping jaws are produced using a CAD/CAM process.

This takes the method according to the invention to another level of automation.

It is further proposed that a coupling agent is applied onto the surface of the recesses or onto the surface of the prosthetic tooth or onto the surfaces of the prosthetic teeth before placing the clamping jaws against the prefabricated prosthetic tooth or the prefabricated prosthetic teeth.

This can provide a better hold of the prosthetic teeth in the recesses of the clamping jaws. However, the coupling agent typically has to be removed from the prosthetic teeth unless it evaporates on its own.

Furthermore, according to the invention, the clamping jaws can be placed against the prosthetic tooth or the prosthetic teeth in such a manner that the placed clamping jaws form a complete ring around the prosthetic tooth or the prosthetic teeth at a middle circumference each and that the clamping jaws lie flat on one another on both sides of the prosthetic tooth or the prosthetic teeth, wherein each prosthetic tooth is fixed in a separate continuous passage of the placed-together clamping jaws and each passage is formed by the recesses of at least two clamping jaws in step 1), and the clamping jaws are fastened to one another in step 2).

This results in fixation of the prosthetic teeth on all sides.

The objects of the invention are also achieved by a device for holding prosthetic teeth, comprising at least two clamping jaws that can be or are placed together and comprise recesses arranged on the periphery of the clamping jaws, wherein the device in its placed-together state comprises at least one continuous passage or at least one continuous gap, preferably multiple continuous passages, wherein each passage or gap is defined by the recesses arranged on the periphery of the clamping jaws of at least two clamping jaws each, wherein the inner surfaces of the recesses, at least in certain regions, form a negative of a portion of the surface of a specific prefabricated prosthetic tooth, such that, when said specific prosthetic tooth is inserted in the passage or the recesses of the gap, it is held in a press fit from at least three directions by the placed-together clamping jaws that are fastened to one another.

Continuous means in this context that the passage or gap extends from one side to an opposite side of the placed-together clamping jaws.

Fastening means can be provided on the clamping jaws with which the clamping jaws can be fastened to one another.

It is preferred that bore holes with a female thread are provided in the clamping jaws or on the clamping jaws, which in the placed-together state are on top of one another, wherein the device comprises a screw or preferably multiple screws with a male thread that matches said female thread. The clamping jaws can be screwed together with the screw or screws.

Alternatively, bore holes without a female thread can be provided and the clamping jaws can be fastened to one another using a screw and a lock nut.

Other possible embodiments of the fastening means are click connections, tongue and groove connections, latching connections, or plug connections. Such fastening means are preferably disposed on the connecting surfaces between the clamping jaws.

A further development of the invention proposes that the clamping jaws are made of a hard non-deformable material, preferably of a material with a modulus of elasticity of at least 1.5 GPa, particularly preferred at least 4 GPa.

Materials with such modules of elasticity are particularly suited for the clamping jaws because the dimensional stability of the clamping jaws is particularly important.

The prosthetic tooth or the prosthetic teeth may also be fixable in a predetermined position and orientation only in the placed-together clamping jaws.

This ensures a distinct position and orientation of the prosthetic teeth.

It is also proposed that the coronal end and the basal end of the prosthetic tooth or the coronal ends and the basal ends of the prosthetic teeth project on both sides of the placed-together clamping jaws when the prosthetic tooth or the prosthetic teeth is/are inserted in the placed-together clamping jaws to make it possible that the clamped prosthetic teeth can be reworked from both sides, namely, the coronal side or occlusal side and the basal side.

The objects of the invention are also achieved by a kit for performing such a method, comprising at least one prefabricated prosthetic tooth, preferably a plurality of prefabricated prosthetic teeth, and at least one such device.

The kit may additionally include a carrier with at least one cavity for receiving a coronal or basal end of at least one prefabricated prosthetic tooth, particularly a carrier plate with at least one cavity for receiving a coronal or basal end of a prefabricated prosthetic tooth.

The combination of the kit with a carrier makes the kit more complete and easier to use for a user.

Finally, the kit may in addition contain the first dataset of the outer shape of all prefabricated prosthetic teeth and the second dataset of the position of the prefabricated prosthetic teeth in the placed-together clamping jaws, preferably on a data carrier.

This makes fully automated reworking of the prosthetic teeth easier.

The invention is based on the surprising finding that, when using prefabricated prosthetic teeth with a known and/or standardized shape and clamping jaws matching said prefabricated prosthetic teeth, it is possible to clamp the prosthetic teeth firmly and aligned in a middle section, such that the prosthetic teeth are both basally and coronally accessible and can be reworked. The method and the device and the kit are particularly well suited for machining using a CAD/CAM process. The reworked prosthetic teeth can be removed without residue by loosening the fastening means of the clamping jaws and will immediately be available for treatment of a patient. The prosthetic teeth can be fastened quickly and easily. The clamping jaws can be reused without a problem. The method according to the invention does not need a rather complex manufacturing of the holder as required for wax holders.

The device and the clamping jaws are resistant to external influences such as heat or cold, and there will be no warping or deformation of the device or the clamping jaws, respectively and therefore no changes in the position of the prosthetic teeth inside the device or the clamping jaws, respectively.

The great advantage of methods according to the invention is that they can be implemented fast and almost without any tools and aids. They do not require that large volumes of materials are kept in stock and allow order-related preparation. It is also no longer required to clean the prosthetic teeth by boiling out or brushing, which has to be done when using wax.

The method is also highly efficient when it comes to costs because the clamping jaws can be reused depending on the degree to which the prosthetic teeth have to be ground.

It has been found that good fixation of the prosthetic teeth can surprisingly be achieved even at low heights of the clamping jaws. Applying coupling agents can further improve bonding. Polyvinyl alcohol is an example of a coupling agent that can be used, which forms an adhesive bonding layer after evaporating solvents contained therein.

The invention can for example include that the prosthetic teeth are provided in the clamping jaws as their holder, such that they can immediately be ground by machine in a CAM process and adjusted to the individual situation of the patient. It is primarily the basal surface that is ground but the occlusal surface can also be reworked by machine for individual adjustment of the chewing function.

In order to implement this technical approach, the prefabricated prosthetic teeth have to be positioned and held in a predefined position inside the clamping jaws that can be chucked into the machine. The placed-together clamping jaws can have various shapes (square, rectangular, round, etc.) and are expediently adapted to the receiving mechanism of the respective CAM machine. According to the invention, a holder can be provided on the clamping jaws or at least on one of the clamping jaws for fastening the same in the CAM machine. The clamping jaws hold the prefabricated prosthetic teeth in a press fit. The prosthetic teeth and the clamping jaws are not damaged when the prosthetic teeth are removed and can optionally be reused.

The prosthetic teeth are fixed using two prefabricated molded parts or clamping jaws, respectively. These are positioned laterally on the prosthetic tooth and then fixed against one another (for example by gluing, screwing, a click mechanism with retainers). In this way, the prosthetic teeth are clamped in a defined position and orientation between the clamping jaws. The positioning of the two clamping jaws against one another can optionally be secured by additional guides, alignment pins, or the like.

Optionally, the clamping jaws are reusable by opening them and inserting new prosthetic teeth. The clamping jaws have an outer geometry that is adapted to the receivers of various milling cutters.

The clamping jaws are made of a material that is resistant to permanent deformation, such as an elastic plastic material like polymethylmethacrylate (PMMA) or polyurethane (PU) or other plastic materials with filler contents, or metallic materials. It is preferred that the clamping jaws are produced by milling, but they can also be produced by injection molding or sintering.

According to the invention, it is preferred that the clamping jaws have a height in the range from 3 mm to 10 mm for a better grip on the prosthetic teeth. Optionally, an additional coupling agent (such as polyvinyl alcohol, PVA) can be introduced before inserting the prosthetic teeth.

Optionally, an additional base plate is used for prepositioning of the prosthetic teeth.

Embodiments of the invention will now be explained with reference to nine schematic figures below, however without limiting the invention. Wherein:

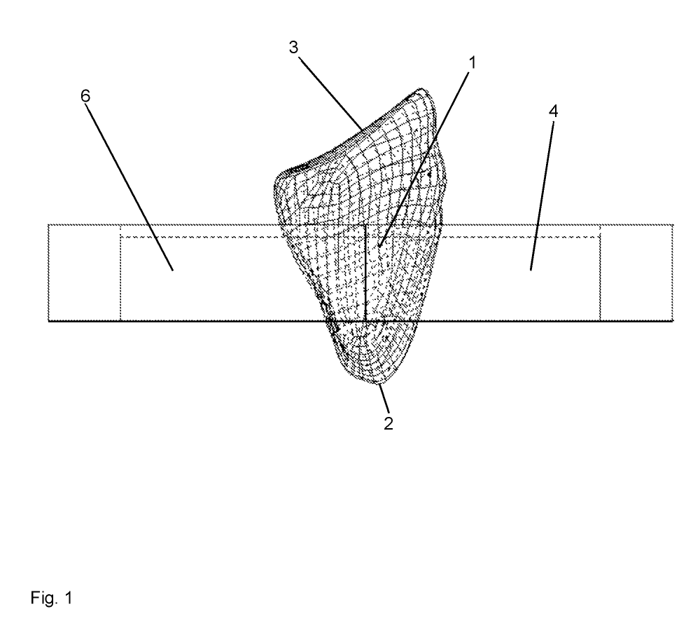

FIG. 1 shows a schematic transparent side view of a device according to the invention;

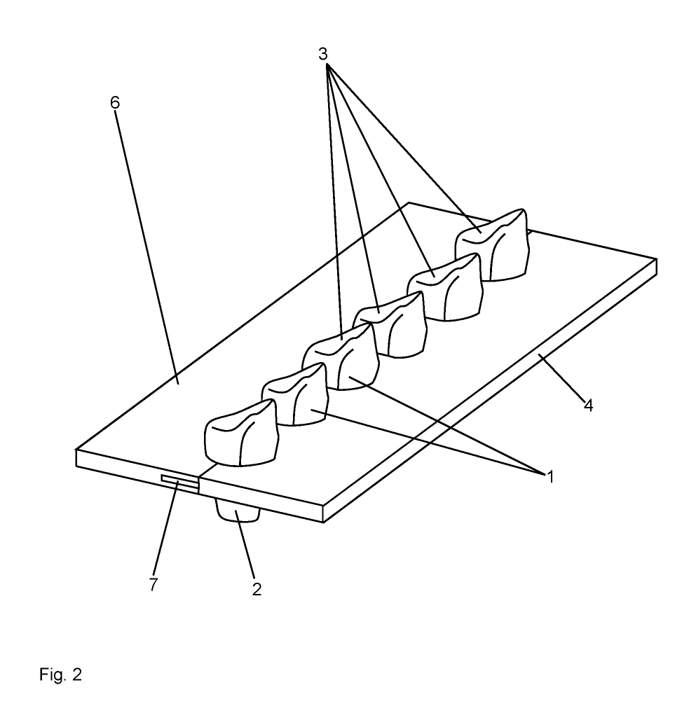

FIG. 2 shows a schematic perspective view of a device according to the invention in which six prosthetic teeth are fixed;

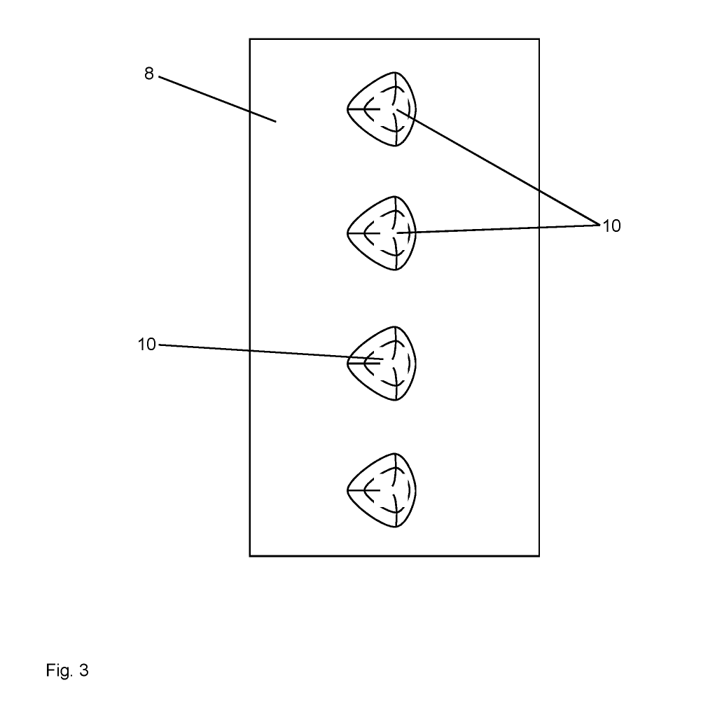

FIG. 3 shows a schematic top view of a carrier plate of a kit according to the invention;

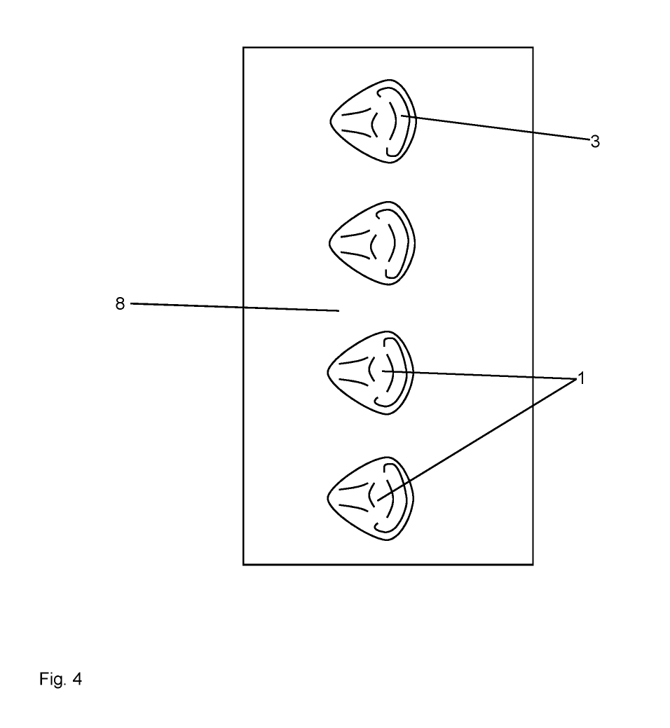

FIG. 4 shows a schematic top view of a carrier plate of a kit according to the invention with four prosthetic teeth inserted;

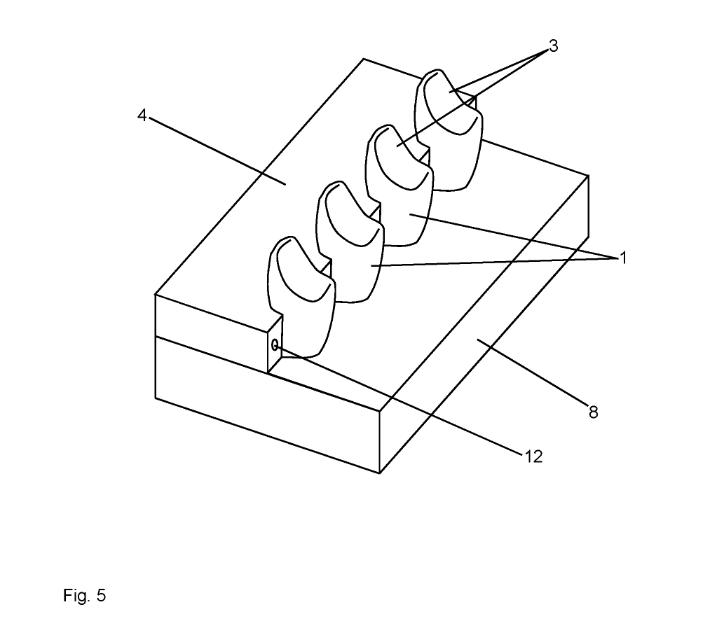

FIG. 5 shows a schematic perspective view of a clamping jaw of a device according to the invention placed on a carrier plate and against the prosthetic teeth;

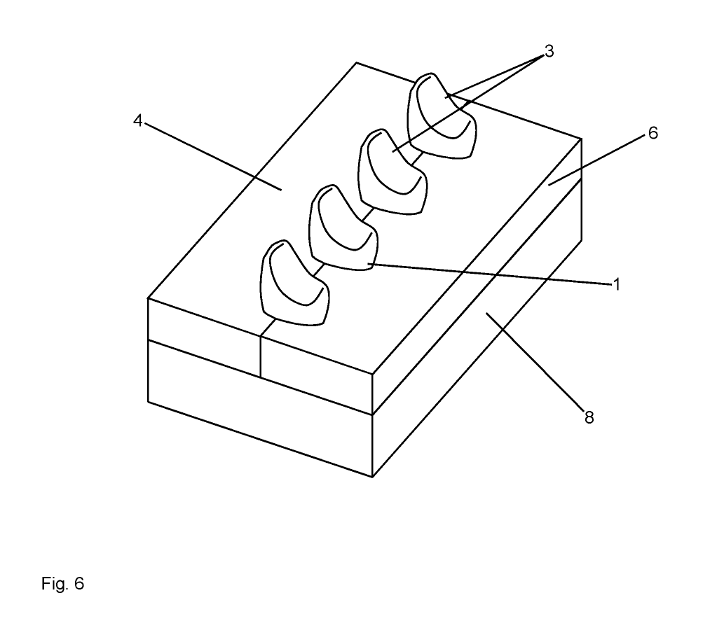

FIG. 6 shows a schematic perspective view of two clamping jaws of a device according to the invention placed on a carrier plate and against prosthetic teeth;

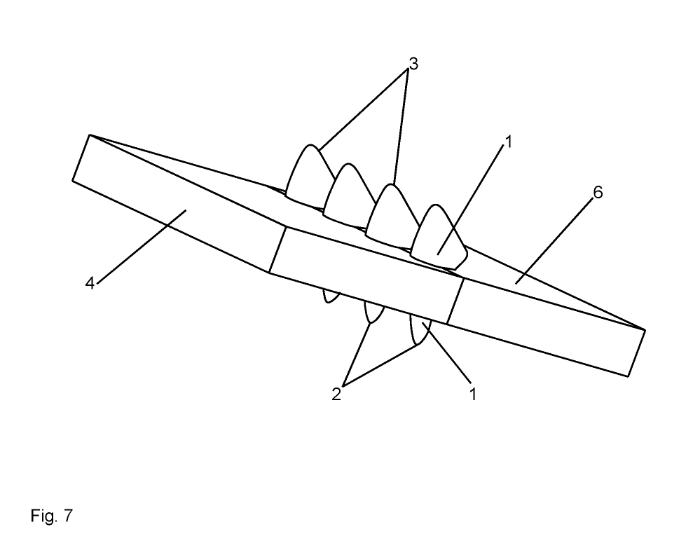

FIG. 7 shows a schematic perspective view of a device according to the invention in which four prosthetic teeth are fixed;

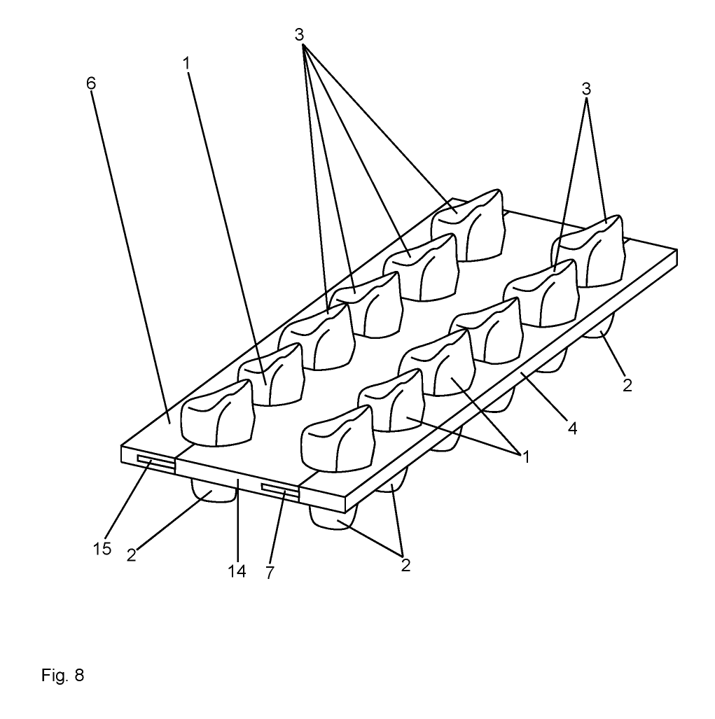

FIG. 8 shows a schematic perspective view of a device according to the invention with three clamping jaws in which twelve prosthetic teeth are fixed; and

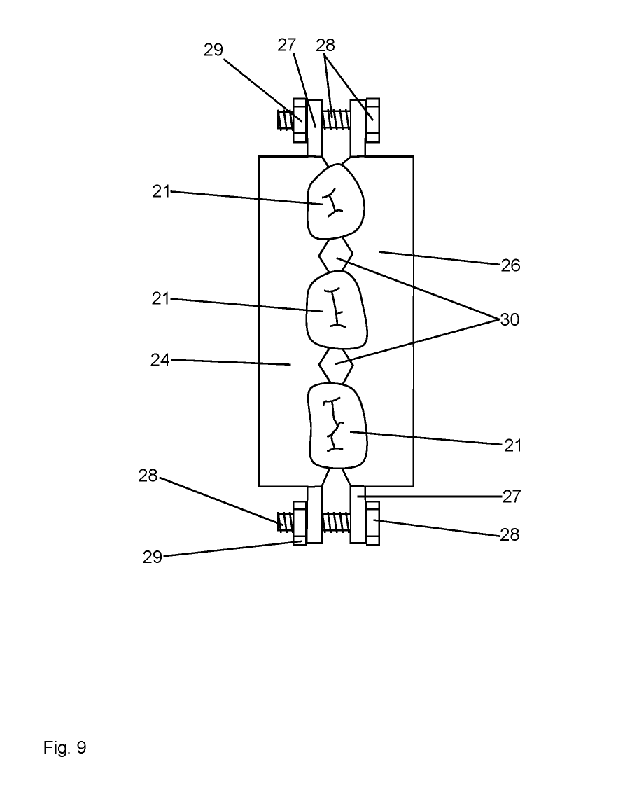

FIG. 9 shows a schematic top view of another device according to the invention in which three prosthetic teeth are fixed.

The same parts are mostly identified by the same reference symbols are used in the figures, even in different embodiments.

FIG. 1 shows a schematic transparent side view of a device according to the invention. A prosthetic tooth 1 with a basal end 2 and a coronal end 3 is clamped in the device. The device comprises two clamping jaws 4, 6 made of a dimensionally stable plastic material between which the prosthetic tooth 1 is clamped. The dashed lines indicate that the clamping jaws 4, 6 are somewhat flatter in the direction towards the prosthetic tooth 1. The advantage of this is that the raised frame formed by the placed-together clamping jaws 4, 6 provides higher stability of the overall device and at the same time makes as large portions as possible of the prosthetic tooth 1 or the basal side 2 and the coronal side 3 of the prosthetic tooth 1, respectively, accessible for machining. The central solid line between the clamping jaws 4, 6 represents the contact surface between the placed-together clamping jaws 4, 6.

The prosthetic tooth 1 is initially held using a carrier (not shown). The carrier holds the prosthetic tooth 1 either on the basal side 2 or on the coronal side 3. The middle region in between against which the clamping jaws 4, 6 are to be placed must not be covered by the carrier. Subsequently, the clamping jaws 4, 6 are placed against said middle region and connected to one another using a fastening means (not shown). For this purpose, the clamping jaws have peripheral recesses which contain the prosthetic tooth 1 in FIG. 1. These peripheral recesses form a continuous passage through the device when the clamping jaws 4, 6 are placed together and no prosthetic tooth 1 is inserted, which passage is used to hold the prosthetic tooth 1.

As an alternative to using a carrier, the prosthetic tooth 1 can also be directly plugged into the recess of one of the clamping jaws 4. In this case, reasonably accurate positioning should be ensured. Then the second clamping jaw 6 is placed, pressed on, and fastened to the first clamping jaw 4. This will give the prosthetic tooth 1 the desired orientation and fixation.

A glue or adhesive can be used to hold the clamping jaws 4, 6 in position against one another. However, a detachable fastening means such as a screw or an easily detachable fastening means like a clamp are preferred. It is important that the two clamping jaws 4, 6 and the prosthetic tooth 1 are rigidly and positionally fixed against one another such that the exact position and orientation of the prosthetic tooth 1 is clearly defined when the device with the prosthetic tooth 1 is chucked into a milling cutter or another device for performing a subtractive procedure on the prosthetic tooth 1. On the one hand, the prosthetic tooth 1 must not move due to the mechanical strains exerted during machining, on the other hand its original position must be exactly known when using CAM techniques to satisfy the high precision requirements with respect to the exact shape of prosthetic teeth.

The clamping jaws 4, 6 must be made of a hard, rigid, and, most of all, dimensionally stable material to ensure exact positional fixation of the prosthetic tooth 1. The preferred material is a hard plastic or synthetic material such as PMMA or PU. The exact retention of the prosthetic tooth 1 is particularly and preferably possible, according to the invention, if the recesses in the clamping jaws 4, 6 in which the prosthetic tooth 1 is held or is to be held are produced based on the same shape or the same data, respectively, that was used to produce the prosthetic tooth 1 itself. Thus, if both the prosthetic tooth 1 and the inner surfaces of the recess of the clamping jaws 4, 6 are produced using a CAD/CAM process based on the same data with respect to the shape of the surfaces, it is possible to achieve an exact fit and a stable fixed position and orientation of the prosthetic tooth 1 in the device. This finding according to the invention also applies in general and to all other embodiments. Since the number of available prosthetic teeth 1 made by CAD/CAM processes in the market is on a steady increase, the setup according to the invention can be used more and more frequently.

The basal side 2 and the coronal side 3 of the prosthetic tooth 1 project from the placed-together clamping jaws 4, 6, such that both sides 2, 3 can be machined in one process step.

FIG. 1 shows only one prosthetic tooth 1. Other prosthetic teeth (not visible in FIG. 1) can be located in a row behind it, as shown in FIG. 2.

FIG. 2 shows a schematic perspective view of a device according to the invention in which six prosthetic teeth 1 are fixed, each having a basal side 2 and a coronal side 3. The device consists of two parts, a first clamping jaw 4 and a second clamping jaw 6. The first clamping jaw 4 comprises on its edge on the connecting surface to the second clamping jaw 6 at least a pin 7 or at least a tongue 7 which can be plugged into a groove or depression on the corresponding abutting side of the second clamping jaw 6. The two clamping jaws 4, 6 can be firmly connected to one another through said groove-and-tongue system.

Six recesses are provided in the clamping jaws 4, 6 on their edges on the connecting side to the respective other clamping jaw 4, 6, which are roughly semicircular such that they form roughly circular passages in the placed-together device, wherein their inner surfaces actually represent a negative of the outer shape of the prosthetic teeth 1 to be used, such that exactly one prosthetic tooth 1 can be fixed in each one of the six passages or in each one of the six recesses, respectively. Except for the embodiment according to FIG. 9, only one type of prosthetic teeth 1 or very similar prosthetic teeth 1 is/are shown here and in the following embodiments. However, different prosthetic teeth 1 can each distinctly be insertable in the recesses as replacements for incisors, molars, canines, etc. To be exact, a device in which various prosthetic teeth 1 for different tooth types can be held is preferred according to the invention.

The inner surfaces of the recesses are adapted to the outer shape of the respective prosthetic tooth 1, such that each prosthetic tooth 1 is assigned a specific recess in the clamping jaw 4, 6 and thus a specific position or a specific passage, respectively, in the placed-together device. These explanations represent a generally valid principle of an advantageous embodiment of the invention and can be applied to all embodiments for holding multiple prosthetic teeth 1. The advantage is that reworking of multiple prosthetic teeth 1 for a single patient can be performed.

The prosthetic teeth 1 are arranged in a row in FIG. 2. If the recesses are arranged accordingly, these teeth can also be arranged at an offset from one another. When using more than two clamping jaws 4, 6, more than one row of prosthetic teeth 1 can be held (see the embodiment according to FIG. 8). The clamping jaws 4, 6 are again made of a rigid and hard and dimensionally stable material. The material has a modulus of elasticity of at least 10 GPa to resist deformation of the clamping jaws 4, 6 under the mechanical stresses due to the reworking of the prosthetic teeth 1.

The device with the clamped and fixed prosthetic teeth 1 can be chucked into a computer-controlled (CAM) four-axis milling cutter to machine the accessible basal sides 2 and coronal sides 3 of all prosthetic teeth 1. The groove of the second clamping jaw 6 and the tongue 7 of the first clamping jaw 4 are used as fastening means. The prosthetic teeth 1 must be held in the correct positions for being clamped in the clamping jaws 4, 6. A carrier plate (not shown) can be used for this purpose.

FIG. 3 shows a schematic top view of such a carrier plate 8 of a kit according to the invention for implementing a method according to the invention. The sequence of method steps according to the invention is shown in FIGS. 3 to 7.

The carrier plate 8 can be made of a simple plastic material. The carrier plate 8 shown includes four cavities 10 for positioning prosthetic teeth (not shown in FIG. 3). The cavities 10 represent a negative of the outer shape of four basal ends of prosthetic teeth, such that the prosthetic teeth can and have to be inserted at a distinct position and in the correct orientation. As an alternative to the uniform cavities 10 shown, it is preferred that different cavities 10 are provided for different prosthetic teeth of different tooth types. Next, four prosthetic teeth 1 are inserted into the cavities 10.

FIG. 4 shows a schematic top view of the carrier plate 8 of a kit according to the invention with four prosthetic teeth 1 inserted. The prosthetic teeth 1 can only be inserted in a specific position and a specific orientation into the cavities 10. The prosthetic teeth 1 are only placed loosely in the carrier plate 8. Alternatively, the prosthetic teeth 1 can adhere to the cavities 10 using a coupling agent or be held in a slight press fit in the cavities 10 by a suitable shape of the cavities 10. In such an arrangement, the coronal sides 3 of the prosthetic teeth 1 are exposed. Alternatively, the prosthetic teeth 1 can be placed with their coronal sides 3 in matching cavities 10. A mixed orientation is also possible, though not advantageous.

Next, a first clamping jaw 4 made of a material with a sufficiently high modulus of elasticity (more than 1.5 GPa) and with semicircular recesses that match the outer shape of the four prosthetic teeth 1 positioned in the carrier plate 8 is placed on the carrier plate 8 and against the prosthetic teeth 1. FIG. 5 shows a schematic perspective view of the first clamping jaw 4 of a device according to the invention placed on the carrier plate 8 and against prosthetic teeth 1. The inner surfaces of the recesses match the outer shapes of the prosthetic teeth 1 in a middle region that begins at a level of the prosthetic teeth 1 projecting from the cavities 10 of the carrier plate 8.

The inner surfaces of the four recesses and the shape of the cavities 10 can be produced using a CAD/CAM process by using the molds used for making the prosthetic teeth 1 as a dataset which is read or scanned in advance. Click mechanisms 12 or latching connections 12 that match their respective counterparts on the connecting surface of the second clamping jaw 6 are provided on the connecting surface to a second clamping jaw 6 (not visible in FIG. 5). Placing the second clamping jaw 6 against the first is the next process step.

FIG. 6 shows a schematic perspective view of two clamping jaws 4, 6 of a device according to the invention placed on the carrier plate 8 and against the four prosthetic teeth 1. The clamping jaws 4, 6 are connected to one another by the click mechanisms 12 or latching connections 12. The clamping jaws 4, 6 could also be divided once or several times into a larger number of clamping jaws without particular disadvantages. For example, two clamping jaws 4, 6 could be provided for each prosthetic tooth 1, and the various clamping jaws 4, 6 could be laterally connectible to one another. Such a system has the advantage that only the desired prosthetic teeth 1 are clamped and there are no unfilled passages remaining in the device. Such a system represents a particularly variable further development of the present invention, which is therefore preferred according to the invention. The second clamping jaw 6 is also placed on the carrier plate 8 and against the prosthetic teeth 1. Like the first clamping jaw 4, the second clamping jaw 6 comprises recesses that fit the prosthetic teeth 1, which recesses halfway enclose the prosthetic teeth 1 in a middle region and are in positive fitting contact and flush with said region.

Theoretically, it is sufficient if just partial areas of the inner surfaces of the recesses of the two clamping jaws 4, 6 abut with the prosthetic teeth 1. The placed-together clamping jaws 4, 6 should press against the prosthetic teeth 1 from at least three directions to hold them stably and prevent them from rotating about an axis in the plane of the clamping jaws 4, 6. However, it is better and preferred according to the invention, that the recesses of the clamping jaws 4, 6 or the passages of the device formed by said recesses of the placed-together clamping jaws 4, 6 are in positive fitting contact and flush with said prosthetic teeth 1 around the entire circumference because this, on the one hand, ensures a stable hold of the prosthetic teeth 1 in the device and on the other hand helps prevent the risk of deformation or damage of the prosthetic teeth 1 by the hard clamping jaws 4, 6. The higher the modulus of elasticity of the material used for the clamping jaws 4, 6 can be selected, the more accurately the prosthetic teeth will be positioned and oriented while being machined.

The subjacent carrier plate 8 is removed after fixing the prosthetic teeth 1 in the middle region between the basal end 2 and the coronal end 3 of the prosthetic teeth 1 by the clamping jaws 4, 6.

FIG. 7 shows a schematic perspective view of the device in which four prosthetic teeth 1 are fixed and the carrier plate 8 has been removed. It is well visible that the basal sides 2 and the coronal sides 3 of the prosthetic teeth 1 are accessible, each on one side of the device, and can be machined. The device with the four fixed prosthetic teeth 1 therein is then chucked into a four-axis milling cutter or another device for implementing a CAM process.

The prosthetic teeth 1 can be machined based on data recorded in advance in the oral cavity to adjust the prosthetic teeth 1 to the situation in the oral cavity. The prosthetic teeth 1 are machined basally for a good fit, and the coronal sides 3 of the prosthetic teeth 1 are machined to achieve good occlusion. Such methods are known; for details, see WO 2011/066 895 A1.

After machining the prosthetic teeth 1, the device is removed from the milling cutter and the two clamping jaws 4, 6 are separated from one another. The prosthetic teeth 1 are then available individually and can be inserted in a patient's mouth.

FIG. 8 shows a schematic perspective view of an alternative device according to the invention with three clamping jaws 4, 6, 14 in which twelve prosthetic teeth 1 are fixed in two rows. The first clamping jaw 4 and the second clamping jaw 6 each comprise six semicircular recesses for receiving the prosthetic teeth 1. The central third clamping jaw 14 comprises six semicircular recesses each on two opposite edge sides, such that the third clamping jaw 14 has a total of twelve recesses.

The prosthetic teeth 1 may previously have been supported on two carrier plates or on another carrier or a holder in the positions and orientations shown, in a row in each case, or the prosthetic teeth 1 are simply plugged into the recesses of the central base plate 14. The positions on the carrier do not yet have to be exact, since the prosthetic teeth 1 are brought into the correct position and orientation when the clamping jaws 4, 6, 14 are placed against them and fastened, if the deviations on the carrier were small only.

A tongue 7 of the first clamping jaw 4 is plugged into a groove of the third clamping jaw 14, and the two clamping jaws 4, 14 with the fixed prosthetic teeth 1 in their recesses are fastened to one another in this manner. Then six more prosthetic teeth 1 are placed against the six recesses of the third clamping jaw 14 left empty with or without a carrier system, and the third clamping jaw 14 is connected with a tongue 15 to a groove of the second clamping jaw 6.

Alternatively, the middle region of the central clamping jaw 14 can already be placed on or loosely fastened to a single carrier plate (not shown), then the prosthetic teeth 1 are inserted into twelve cavities of the carrier plate and placed against the twelve recesses of the central clamping jaw 14. Then the two other clamping jaws 4, 6 are placed from outside against the prosthetic teeth 1 in the carrier plate and against the central clamping jaw 14. Then the carrier plate is removed, resulting in the setup shown in FIG. 8.

At any rate, the fixed prosthetic teeth 1 can subsequently be basally and coronally machined because both the basal sides 2 and the coronal sides 3 of the prosthetic teeth 1 are accessible.

FIG. 9 shows a schematic top view of another alternative embodiment of the invention. In the device shown, three prosthetic teeth 21 are fixed between two clamping jaws 24, 26. The occlusion surfaces of the prosthetic teeth 21, that is, the coronal sides of the prosthetic teeth 21 can be seen in the top view in FIG. 9. Unlike the embodiments shown before, the two clamping jaws 24, 26 are not in direct contact but separated from one another by the prosthetic teeth 21 and a gap 30.

An orifice plate 27 with which the clamping jaws 24, 26 can be fastened to one another is attached on each two opposite sides of the clamping jaws 24, 26. Fastening is achieved using a screw 28 which is inserted through holes of the orifice plates 27 of both clamping jaws 24, 26 and fixed with a lock nut 29 on the opposite side.

The prosthetic teeth 21 are each in positive fitting contact and flush with three recesses of the clamping jaws 24, 26. Since the clamping jaws 24, 26 are spaced apart from one another the entire pressure is only applied to the prosthetic teeth 21, which results in a particularly stable hold. The pressure comes primarily from two directions (in FIG. 9 from the right and from the left) while the holding force in the direction perpendicular to the direction of pressure (in FIG. 9 from the top and the bottom) is weaker than in a completely encompassing fit. The recesses of the clamping jaws 24, 26 do not form any passages through the device. Instead, a gap 30 remains in the device in the placed-together state, wherein the prosthetic teeth 21 inside the gap 30 are positioned in the recesses of the clamping jaws 24, 26 provided for this purpose.

A simple screw clamp with flat pressing jaws would be unsuitable since it would exert too great a point load on the prosthetic teeth 1, 21 and allow rotation about the axis of the contact points. It is therefore of critical importance for the present invention that a flat or positive fitting surface contact is obtained between the prosthetic teeth 1, 21 and the clamping jaws 4, 6, 14, 24, 26.

The features of the invention disclosed in the above description, the claims, figures, and exemplary embodiments can be essential both individually and in any combination for implementing the various embodiments of the invention. It is understood that, in addition to the embodiments with one, three, four, six, and twelve prosthetic teeth shown here, the device for the numbers of prosthetic teeth shown can be transferred to other even and odd numbers of prosthetic teeth.

### LIST OF REFERENCE SYMBOLS

1 Prosthetic tooth
2 Basal side of a prosthetic tooth
3 Coronal side of a prosthetic tooth
4 Clamping jaw
6 Clamping jaw
7 Tongue/pin
8 Carrier plate
10 Cavity/receptacle
12 Click mechanism/latching
14 Central clamping jaw
15 Tongue
21 Prosthetic tooth
24 Clamping jaw
26 Clamping jaw
27 Orifice plate
28 Screw
29 Nut
30 Gap

1. A method for positioning and machining prosthetic teeth, comprising the following method steps:
(a) placing together at least two clamping jaws having two sides and peripheral recesses with the peripheral recesses against a prefabricated prosthetic tooth or against prefabricated prosthetic teeth, such that, at least in certain regions, the placed clamping jaws enclose the prosthetic tooth or the prosthetic teeth respectively around a middle circumference, wherein, at least in certain regions, inner surfaces of the recesses positively fit regions of outer surfaces of the prosthetic tooth or the prosthetic teeth, wherein the clamping jaws are placed against the prosthetic tooth or the prosthetic teeth in such a manner that a coronal end and a basal end of the prosthetic tooth or coronal ends and basal ends of the prosthetic teeth project on both sides of the placed-together clamping jaws; and
(b) fastening the clamping jaws to one another.

2. The method according to claim 1, comprising placing the clamping jaws against the prosthetic tooth or the prosthetic teeth in such a manner that the clamping jaws are in positive fitting contact and flush with one another and/or with the prosthetic tooth, or the clamping jaws are in positive fitting contact and flush with one another and/or with the prosthetic teeth.

3. The method according to claim 1, comprising coronally and/or basally setting the prefabricated prosthetic tooth or the prefabricated prosthetic teeth onto a carrier before being fixed by the clamping jaws, and removing the carrier from the clamping jaws and the prosthetic tooth or prosthetic teeth held in the clamping jaws after the clamping jaws have been connected to one another.

4. The method according to claim 3, comprising placing the clamping jaws against the prosthetic tooth or the prosthetic teeth while on the carrier.

5. The method according to claim 3, comprising using a carrier plate with at least one cavity for at least one prefabricated prosthetic tooth as the carrier, wherein the at least one cavity forms a negative of an outer shape of a coronal end or a basal end of a prefabricated prosthetic tooth.

6. The method according to claim 1, comprising after removing the carrier, fastening the clamping jaws attached-to one another in a defined position in a holder of a CAM device for material removal from the prosthetic teeth or the prosthetic tooth in a CAM process, and machining at least one coronal end and/or at least one basal end of at least one prosthetic tooth in a computer-controlled process using the CAM device.

7. The method according to claim 1, wherein the outer shapes of all prefabricated prosthetic teeth used are available as a first dataset, and a second dataset defines the exact positions of all fixed prefabricated prosthetic teeth in the placed-together clamping jaws, wherein subsequent machining of the prosthetic tooth or the prosthetic teeth is performed based on the first and the second dataset.

8. The method according to claim 1, wherein all prefabricated prosthetic teeth are each fixed in one predetermined position and orientation only in the placed-together clamping jaws.

9. The method according to claim 1, comprising producing the prefabricated prosthetic tooth or the prefabricated prosthetic teeth using a CAD process, using the data used to determine the outer shape of the surface of the prefabricated prosthetic tooth or the prefabricated prosthetic teeth for shaping the recesses of the clamping jaws.

10. The method according to claim 1, comprising applying a coupling agent onto the surface of the recesses or onto the surface of the prosthetic tooth or onto the surfaces of the prosthetic teeth before placing the clamping jaws against the prefabricated prosthetic tooth or the prefabricated prosthetic teeth.

11. The method according to claim 1, comprising placing the clamping jaws against the prosthetic tooth or the prosthetic teeth in such a manner that the placed clamping jaws form a complete ring around the prosthetic tooth or the prosthetic teeth at a middle circumference each and that the clamping jaws lie flat on one another on both sides of the prosthetic tooth or the prosthetic teeth, wherein each prosthetic tooth is fixed in a separate continuous passage of the placed-together clamping jaws and each passage is formed by the recesses of at least two clamping jaws in step 1), and the clamping jaws are fastened to one another in step (b).

12. A device for holding prosthetic teeth, comprising at least two clamping jaws that can be or are placed together and that comprise recesses arranged on a periphery of the clamping jaws, wherein the device in its placed-together state comprises at least one continuous passage or at least one continuous gap, wherein each passage or gap is defined by the recesses arranged on the periphery of the clamping jaws of at least two clamping jaws each, wherein inner surfaces of the recesses, at least in certain regions, form a negative of a portion of the surface of a specific prefabricated prosthetic tooth, such that, when said specific prosthetic tooth is inserted in the passage or the recesses of the gap, the specific prosthetic tooth is held in a press fit from at least three directions by the placed-together clamping jaws that are fastened to one another.

13. The device according to claim 12, characterized wherein fastening means are provided on the clamping jaws by which the clamping jaws can be fastened to one another.

14. The device according to claim 12, wherein the clamping jaws are made of a hard non-deformable material.

15. The device according to claim 12, wherein the prosthetic tooth or the prosthetic teeth can be fixed in one predetermined position and orientation only in the placed-together clamping jaws.

16. The device according to claim 12, wherein a coronal end and a basal end of the prosthetic tooth or the coronal ends and the basal ends of the prosthetic teeth project on both sides of the placed-together clamping jaws when the prosthetic tooth or the prosthetic teeth is/are inserted in the placed-together clamping jaws.

17. A kit for performing a method according to claim 1, comprising at least one prefabricated prosthetic tooth and a device for holding prosthetic teeth, the device comprising at least two clamping jaws that can be or are placed together and that comprise recesses arranged on a periphery of the clamping jaws, wherein the device in a placed-together state comprises at least one continuous passage or at least one continuous gap, wherein each passage or gap is defined by the recesses arranged on the periphery of the clamping jaws of at least two clamping jaws each, wherein inner surfaces of the recesses, at least in certain regions, form a negative of a portion of the surface of a specific prefabricated prosthetic tooth, such that, when said specific prosthetic tooth is inserted in the passage or the recesses of the gap, the specific prosthetic tooth is held in a press fit from at least three directions by the placed-together clamping jaws that are fastened to one another.

18. The kit according to claim 17, wherein the kit additionally includes a carrier with at least one cavity for receiving a coronal end or a basal end of at least one prefabricated prosthetic tooth.

19. The kit according to claim 17, wherein the kit in addition contains a first dataset of the outer shape of all prefabricated prosthetic teeth and a second dataset of the position of the prefabricated prosthetic teeth in the placed-together clamping jaws.

20. The kit according to claim 17, wherein the device in its placed-together state comprises multiple continuous passages.

21. The method according to claim 5, wherein the carrier plate has a plurality of cavities for a plurality of prosthetic teeth and each cavity forms a negative of the outer shape of a coronal end and/or a basal end of the prefabricated prosthetic teeth.

22. The method according to claim 6, wherein the CAM device is a CAM-controlled milling cutter.

23. The method according to claim 22, wherein the CAM device is a CAM-controlled four-axis milling cutter.

24. The method according to claim 7, comprising performing said subsequent machining of the prosthetic tooth or the prosthetic teeth using a CAD/CAM process.

25. The method according to claim 9, comprising producing at least the recesses in the clamping jaws using a CAD/CAM process.

26. The device according to claim 14, wherein the hard non-deformable material has a modulus of elasticity of at least 1.5 GPa, particularly preferred at least 4 GPa.

27. The device according to claim 26, wherein the hard non-deformable material has a modulus of elasticity of at least 4 GPa.

28. The kit according to claim 18, wherein the carrier is a carrier plate.

29. The kit according to claim 19, wherein the kit in addition contains the first dataset and the second dataset on a data carrier.
